(19) United States
(12) Patent Application Publication
(10) Pub. No.: US 2012/0301101 A1
(43) Pub. Date: Nov. 29, 2012

(54) METHOD FOR OPERATING A RECORDING ASSEMBLY

(75) Inventor: Hans-Juergen Busch, Schwabach (DE)

(73) Assignee: ROBERT BOSCH GMBH, Stuttgart (DE)

(21) Appl. No.: 13/513,478

(22) PCT Filed: Nov. 9, 2010
(86) PCT No.: PCT/EP10/67124

§ 371 Date: Aug. 8, 2012

(30) Foreign Application Priority Data
Dec. 1, 2009 (DE) 10 2009 047 365.3

(51) Int. Cl. H04N 5/765; H04N 5/77

(52) U.S. Cl. 386/224; 386/200; 386/E05.002; 386/E05.069

(57) ABSTRACT

The invention relates to a method for operating a recording assembly (10) and such a recording assembly (10). The recording assembly (10) according to the invention has at least one active video recording system (12, 14, 16) and at least one security video recording system (18) wherein the at least one security video recording system (18) determines that an active video recording system (12, 14, 16) fails and takes over the function of the failed video recording system (12, 14, 16) by using the configuration thereof, wherein it reconstructs the current recording state from the memory unit (12, 32, 42) allocated to the failed video recording system (12,14.16).

### BACKGROUND OF THE INVENTION

The invention relates to a method for operating a recording assembly comprising at least one video recording system, and to such a recording assembly comprising at least one video recording system.

A video recording system represents a video recording solution for decentralized networks and co-ordinates the recording of video data on external storage devices, usually according to the iSCSI protocol.

The document DE 10 2006 018 959 A1 describes a video recording system for recording video data and a method for storage space distribution in the video recording system. The video recording system described serves for recording video data in a storage network, wherein the storage network comprises interfaces for linking storage servers with storage volume and for linking write clients, wherein at least one write client for providing the video data an allocation device for the storage network is provided and the allocation device is designed for managing the storage volume of the storage servers by virtue of the fact that the allocation device allocates statically divided storage blocks of the storage volume dynamically to the at least one write client. The recording system is distinguished by the fact that at least one surveillance camera which is designed to generate the video data and is interconnected with the at least one write client is provided.

The system is designed in such a way that the co-ordination process can fail for a few hours, without the storage being impaired. Assemblies are known wherein a plurality of video recording systems are used, wherein exactly one so-called security or back-up video recording system is set up for each active video recording system and takes over the tasks of the primary video recording system in the case of a fault. This security system concomitantly runs passively in each case in the system, such that at any time it knows the system state of the active counterpart and can take over the function thereof.

For the case where high redundancy is required, a dedicated security recording system currently has to be provided for each video recording system, which is manifested both in the procurement costs and in the operating costs.

### SUMMARY OF THE INVENTION

Against this background, a method for operating an assembly comprising at least one video recording system and an assembly comprising at least one video recording system are presented.

The method presented makes it possible to provide only one or exactly one security video recording system for a number of active video recording systems, whereby the total costs can be reduced. It goes without saying that a plurality of security video recording systems can also be provided. In this case, one to N security video recording systems are available for replacement.

A plurality of cameras, in particular IP cameras, and iSCSI storage units are assigned to each video recording system in a large recording assembly. This information is designated hereinafter as configuration. On the basis of a configuration, a video recording system can recover all recording information again at any time from an assigned storage unit, regularly an iSCSI storage unit.

The method described here can consist of three sub-steps:

1. The security video recording system ascertains that an active video recording system fails.

2. The security video recording system takes over the function of the failed video recording system by using the configuration thereof.

3. The security video recording system accesses a storage unit assigned to the failed video recording system, and then with knowledge of the recording past of the failed video recording system can completely take over the function thereof. The recording state of the storage unit assigned to the failed video recording system is reconstructed in this way.

The first step can be carried out in three different ways:

1a. Each video recording system sends a signal, i.e. a sign of life, to the security recording system or to the security video recording systems at time intervals, e.g. periodically. If the at least one security video recording system no longer receives a sign of life from a video recording system it is assumed that the latter has failed. The security recording system then takes over the task thereof.

1b. The security video recording system interrogates the state of all video recording systems at time intervals, usually regularly or periodically. If one of the systems does not reply or replies with a fault, then it takes over the task thereof.

1c. The security video recording system monitors the recording of all cameras. If it ascertains, for example, that the cameras of a video recording system are no longer supplied with recording memory, then it takes over the task thereof.

Since the security recording system has knowledge of the configurations of the assigned video recording systems, it can take over the function of each individual video recording system. It is likewise possible to reproduce recordings of a failed video recording system by a security video recording system even during the failure.

The method described makes it possible to use a plurality of security video recording systems for highly redundant systems. In this case, one to N security video recording systems are available as replacement.

### BRIEF DESCRIPTION OF THE DRAWINGS

Further advantages and configurations of the invention are evident from the description and the accompanying drawings.

It goes without saying that the features mentioned above and of those yet to be explained below can be used not only in the combination respectively specified, but also in other combinations or by themselves, without departing from the scope of the present invention.

FIG. 1 shows an embodiment of the recording assembly in a schematic illustration.

FIG. 2 shows a sequence of the method presented in a flow chart.

### DETAILED DESCRIPTION

The invention is schematically illustrated on the basis of embodiments in the drawings and is described thoroughly below with reference to the drawings.

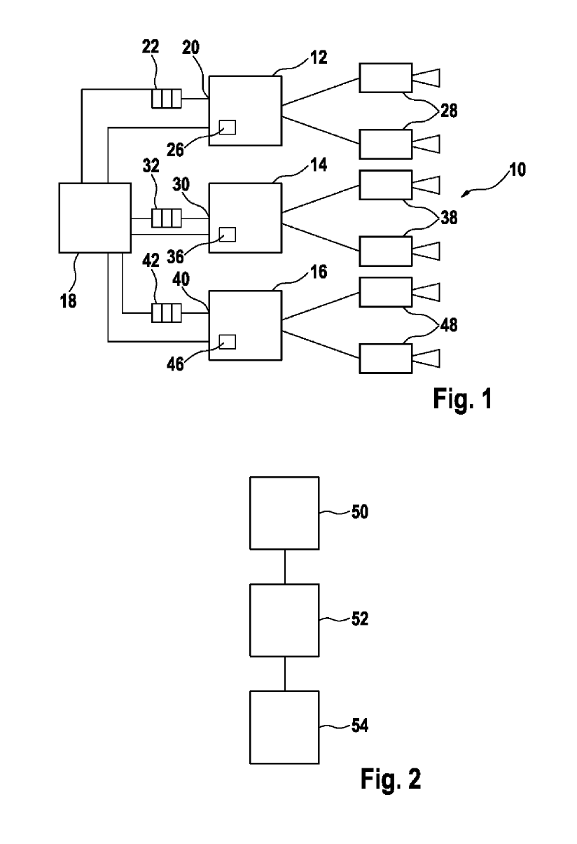

FIG. 1 illustrates a recording assembly, designated in its entirety by the reference numeral 10. Said recording assembly 10 has a first video recording system 12, a second video recording system 14 and a third video recording system 16. Furthermore, a security video recording system 18 is provided.

The first video recording system 12 has a first iSCSI interface 20, via which a first iSCSI storage unit 22 is linked, and a first internal iSCSI memory 26, in which the configuration of the first video recording system 12 is stored. Furthermore, the first video recording system 12 is connected to two cameras 28, usually IP cameras.

Correspondingly, a second iSCSI interface 30, a second iSCSI storage unit 32, a second iSCSI memory 36 and two cameras 38 are provided in the case of the second video recording system 14.

The third video recording system 16 has a third iSCSI interface 40, via which a connection to a third iSCSI storage unit 42 is possible. Furthermore, an internal iSCSI memory 46 is provided. Moreover, two cameras 48 are assigned to the third video recording system 16.

The security video recording system 18 monitors the functioning of the three active video recording systems 12, 14 and 16. If one of the three video recording systems 12, 14 or 16 fails, the security video recording system 18 takes over the function thereof. For this purpose, the security video recording system 18 has knowledge of the configurations of the active video recording systems 12, 14, 16 and the configuration provided for the failed video recording system 12, 14 or 16 is then used as necessary.

In order to ascertain a failure, provision can be made for the security recording system 18 to interrogate the state of the video recording systems 12, 14, 16 regularly. Alternatively, each video recording system 12, 14 or 16 can send signals, serving as signs of life, to the security video recording system 18 at regular intervals. In principle, it is also possible for the security video recording system 18 to monitor the recording of all cameras 28, 38, 48. These three monitoring mechanisms can be carried out, in principle, alternatively or else complementarily.

For the case where more than one security video recording system 18 is provided, they can also use different monitoring mechanisms. In this case, specific properties of specific video recording systems 12, 14, 16 can also be taken into account. Security video recording system 18 can also be assigned to the video recording systems 12, 14, 16 to be monitored.

Furthermore, the security video recording system 18 can access the storage unit 22, 32 or 42 of the failed active video recording system 12, 14 or 16, respectively, and in this way use the data recorded by this system. In this way, it learns the recording past of the failed system and can reconstruct the recording state.

If a plurality of storage units 22, 32 or 42 are assigned to a failed video recording system 12, 14 or 16, respectively, the security video recording system 18 can typically access all assigned storage units 22, 32 or 42, respectively, and thus reconstruct the entire recording state.

FIG. 2 illustrates a possible sequence of the method described in a flow chart. In a first step 50, a security video recording system ascertains that an active video recording system has failed. This can take place by means of a signal exchange between the security video recording system and the active video recording systems or alternatively or supplementarily by the monitoring of the cameras assigned to the video recording systems.

In a second step 52, the security video recording system takes over the function of the failed active video recording system on the basis of the configuration thereof.

In a third step, the security video recording system accesses the storage unit assigned to the failed video recording system and thus learns all data recorded by the failed video recording system and thus the recording past thereof or the recording progression.

1. A method for operating a recording assembly comprising at least one active video recording system and comprising at least one security video recording system, wherein the at least one security video recording system ascertains that an active video recording system fails and takes over the function of the failed video recording system by using the configuration thereof, wherein it accesses a storage unit assigned to the failed video recording system and thus reconstructs a current recording state.

2. The method as claimed in claim 1, wherein the at least one security video recording system ascertains that an active video recording system fails by virtue of the fact that each video recording system sends a signal at time intervals to the at least one security video recording system, such that the at least one security video recording system ascertains failure if a signal is no longer received.

3. The method as claimed in claim 1, wherein the at least one security video recording system ascertains that an active video recording system fails by virtue of the fact that the at least one security video recording system interrogates the state of all active video recording systems at time intervals.

4. The method as claimed in claim 1, wherein the at least one security video recording system ascertains that an active video recording system fails by virtue of the fact that the at least one security video recording system monitors the recording of all cameras which are assigned to the at least one active video recording system.

5. The method as claimed in claim 1, wherein recordings of a failed video recording system can be reproduced by the at least one security video recording system even during the failure.

6. A recording assembly comprising at least one active video recording system and at least one security video recording system, wherein the at least one security video recording system is designed to ascertain failure of an active video recording system and to take over the function of the failed active video recording system by using the configuration thereof, wherein it is possible for the at least one security video recording system is configured to access at least one storage unit assigned to the failed video recording system.

7. The recording assembly as claimed in claim 6, wherein at least one memory for storing the configuration is provided in each video recording system.

8. The recording assembly as claimed in claim 7, wherein the at least one memory is an iSCSI memory.

9. The recording assembly as claimed claim 6, wherein at least two storage units in each case are assigned to active video recording systems.

10. The recording assembly as claimed in claim 6, wherein a plurality of security video recording systems are provided.
